(19) United States
(12) Patent Application Publication
(10) Pub. No.: US 2017/0351715 A1
(43) Pub. Date: Dec. 7, 2017

(54) DETERMINING AN IMPORTANCE CHARACTERISTIC FOR A DATA SET

(71) Applicant: Lenovo Enterprise Solutions (Singapore) Pte. Ltd., Singapore (SG)

(72) Inventors: Gary D. Cudak, Wake Forest, NC (US); Ajay Dholakia, Cary, NC (US); Srihari V. Angaluri, Raleigh, NC (US)

(21) Appl. No.: 15/169,845

(22) Filed: Jun. 1, 2016

(51) Int. Cl. G06F 17/30; G06F 3/06

(52) U.S. Cl. CPC G06F 17/30289; G06F 17/3053; G06F 3/0604; G06F 3/0629; G06F 3/0689

(57) ABSTRACT

A method is provided for obtaining and using a measure of data importance. The method include measuring a data production resource metric for a data set. The method further includes storing the data production resource metric in association with the data set, assigning an importance identifier to the data set as a function of the data production resource metric, and managing system handling of the data set according to the importance identifier assigned to the data set. For example, system handling of the data set may include processing the data set with an application selected from de-duplication, backup, redundancy routines, and tiering.

### BACKGROUND

### Field of the Invention

The present invention relates generally to data management processes, and more particularly to methods of determining an importance to be assigned to various data.

### Background of the Related Art

Data importance is a key determinant in various processing algorithms, including de-duplication routines, backup routines, redundancy routines, and tiering. Implementation of these and other processing algorithms require making proper decisions in regard data storage. These decisions may be facilitated through the use of file management policies and rules.

File management policies may be used to manage files during their lifecycle by moving them to another storage pool, moving them to near-line storage, copying them to archival storage, changing their replication status, or deleting them. A policy rule is a statement that defines what to do with data in response to the data or a related file meeting certain criteria or conditions. For example, a file management policy may include a policy rule that causes data to be handled differently as a function of one or more conditions, such as how recently a file was last accessed or modified, the name or extension of a file or fileset, file size, and an identifier for a user or user group.

In the context of a hypothetical disaster and subsequent disaster recovery, a graduated data storage approach may provide different treatment of data in different classes. For example, these classes may include, in order or increasing importance, data that is non-essential to operation, data that is important for productivity, data that is mission important, data that is business vital, and data that is mission critical. Measures take to safeguard and restore data may then be customized depending upon the class to which certain data is assigned.

### BRIEF SUMMARY

One embodiment of the present invention provides a method comprising measuring a data production resource metric for a data set. The method further comprises storing the data production resource metric in association with the data set, assigning an importance identifier to the data set as a function of the data production resource metric, and managing system handling of the data set according to the importance identifier assigned to the data set.

Another embodiment of the present invention provides a computer program product comprising a non-transitory computer readable storage medium having program instructions embodied therewith, wherein the program instructions are executable by a processor to cause the processor to perform a method. The method comprises measuring a data production resource metric for a data set. The method further comprises storing the data production resource metric in association with the data set, assigning an importance identifier to the data set as a function of the data production resource metric, and managing system handling of the data set according to the importance identifier assigned to the data set.

### BRIEF DESCRIPTION OF THE SEVERAL VIEWS OF THE DRAWINGS

FIG. 1 is a diagram of a computing system capable of implementing embodiments of the present invention.

FIG. 2 is a diagram of a compute node capable of implementing embodiments of the present invention.

FIG. 3 is a flowchart of a method according to one embodiment of the present invention.

### DETAILED DESCRIPTION

One embodiment of the present invention provides a method comprising measuring a data production resource metric for a data set. The method further comprises storing the data production resource metric in association with the data set, assigning an importance identifier to the data set as a function of the data production resource metric, and managing system handling of the data set according to the importance identifier assigned to the data set.

A “data set” is any amount of obtained data that has value to an entity. For example, a data set may be the output generated by running an application or input gathered by an application. While a data set may relate to multiple applications, a data set may more typically related to a single application or single type of application. Furthermore, a data set may be generated or collected over an extended period of time, or as the result of a single occurrence or incident. Generally speaking, a data set has at least one factor or characteristic in common that binds the data together as a set. Examples of a data set of a business enterprise may include year-end accounting reports, customer survey results, product schematics, employee records, and the like. A data production resource metric for each data set may be used in determining an importance identifier to be assigned to the data set.

An importance identifier may be an importance classification or a numerical value of importance. A first non-limiting example of an importance classification may include “low”, “medium” and “high”, while a second non-limiting example may include “non-essential to operation”, “important for productivity”, “mission important”, “business vital”, and “mission critical”. Many other importance classifications can be envisioned. A numerical value of importance may, for example, be set on a scale of 1 to 10, or may be the result of a numerical function of the data production resource metric.

A data production resource metric for a data set may be measured by monitoring an amount of time required to produce the data set as the data set is produced. Alternatively, an amount of time required to produce the data set may be manually entered periodically or after the data set has been completed. In one case, the data set may be entirely generated as the output of a computer program, such that the amount of time required to produce the data set may be the run time of the computer program. In this case, the method may further identify a computing capacity that was used to compute the data set over the amount of time, and calculate a current amount of time to replace the data set. The current amount of time to replace the data set may be equal to the amount of time identified in the data production resource metric multiplied by a ratio of the computing capacity used to compute the data set and a currently available computing capacity. Optionally, both the amount of time and the computing capacity required to produce the data set are stored in association with the data set. Computing capacity may, for example, be measured in millions of instructions per second (MIPS) or similar measure, or a number of processors, servers, or clusters.

In another case, the data set may be obtained entirely through manual data entry by a user of a computer. Accordingly, the data production resource metric may be an amount of time that one or more person has spent interacting with an application to create the data set. Optionally, the method may further comprise calculating an energy cost of replacing the data set, wherein the energy cost of replacing the data set is equal to the amount of time that one or more person spent interacting with an application to create the data set multiplied by a current rate of energy cost to execute the application. Still further, the data production resource metric for a given data set may be a function of both the amount of time one or more person has spent interacting with an application to create the data set and the amount of time required by a computer to generate the data set.

Optionally, the data production resource metric may be an energy cost of producing the data set. Optionally, the energy cost may be a historical energy cost. However, where the metadata identifies an amount of time and a computing capacity used to compute the data set over the identified amount of time, the method may calculate a current energy cost to replace the data set. For example, the current energy cost to replace the data set may be calculating as being equal to the amount of time used to compute the data set multiplied by the computing capacity used to compute the data set and further multiplied by a current rate of energy cost. The current rate of energy cost, such as in units of dollars per kilowatt hour ($/KWh), may obtained from an external source or periodically manually input by a systems administrator. Furthermore, the computing capacity may, in addition to the direct computer (server) capacity, include infrastructure needed to support computation of the data set. Such infrastructure may include switches, storage controllers, monitors, power distribution systems, remote data storage devices, thermal management devices, and the like.

In various embodiments of the present invention, the data production resource metric is stored in association with the data set. For example, the data production resource metric may be stored in metadata that is stored with the data set or stored in a database record along with an identifier of the data set. Storing the data product metric in metadata stored with the data set may provide convenience, such as when determining how to handle the data set. However, in the context of a disaster in which the data set is lost or destroyed, it may be beneficial to have a database of the data production resource metrics that is itself given a high importance identifier. Optionally, the data production resource metric for a given data set may be stored in metadata stored with the given data set, while a copy of the data production resource metric for each data set may be stored as a record in a database.

An importance identifier is assigned to the data set as a function of the data production resource metric. Optionally, the method may include assigning an importance identifier to the data set as a function of the data production resource metric and one or more data usage metric. For example, a data usage metric may include a frequency at which the data set is accessed or used, or a period of time since the data set was last used. Using both metrics, a data set may be handled in a manner that balances a data production resource metric and a data usage metric. Depending upon the circumstances, a data set that is used frequently and has a low energy cost to replace may have more importance than a data set that is used infrequently and has a high energy cost to replace.

There are many ways that the present methods may be used to manage system handling of the data set as a function of the importance identifier assigned to the data set. In one example, the method may make a tiering decision for the data set based on the importance identifier. Accordingly, a first data set with a higher importance identifier may be stored on a highly reliable and resilient data storage device, such as a redundant array of independent disks (RAID), wherein a second data set with a lower importance identifier may be stored on a less reliable and less resilient data storage device, such as a standalone hard disk drive. In another example, the method may establish or alter a frequency of making a backup of the data set based on the importance identifier. Accordingly, a backup of a first data set with a higher importance identifier may be made more frequently that a backup of a second data set having a lower importance identifier. In a further example, the method may determine a number of locations to store or backup the data set based on the importance identifier. Accordingly, a first data set with a higher importance identifier may be stored in more locations than a second data set having a lower importance identifier. In yet another example, the method may use the importance identifier to determine how a de-duplication process will handle a data set.

In a further embodiment, the method may further comprise ranking the data set among a plurality of data sets in order of the importance identifier assigned to each data set. The method may then manage system handling of the data set as a function of the data set ranking.

Another embodiment of the present invention provides a computer program product comprising a non-transitory computer readable storage medium having program instructions embodied therewith, wherein the program instructions are executable by a processor to cause the processor to perform a method. The method comprises measuring a data production resource metric for a data set. The method further comprises storing the data production resource metric in association with the data set, assigning an importance identifier to the data set as a function of the data production resource metric, and managing system handling of the data set according to the importance identifier assigned to the data set.

The foregoing computer program products may further include program instructions for implementing or initiating any one or more aspects of the methods described herein. Accordingly, a separate description of the methods will not be duplicated in the context of a computer program product.

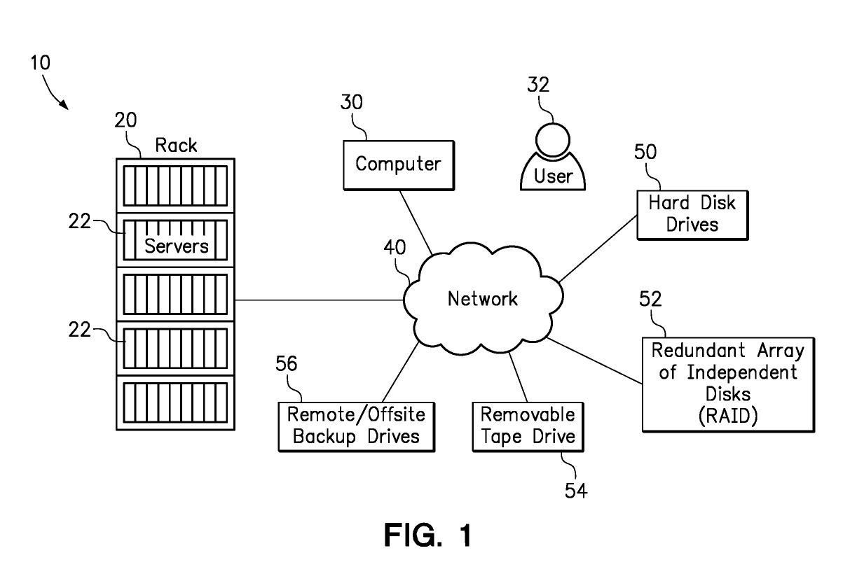

FIG. 1 is a diagram of a computing system 10 capable of implementing embodiments of the present invention. The computing system 10 includes multiple computing devices and multiple data storage devices, including multiple types of data storage devices. In the non-limiting example shown in FIG. 1, the computing system 10, includes a rack 20 supporting a plurality of blade servers 22, and a stand-alone computer 30. The stand-alone computer 30 may be a desktop computer operated by an individual user 32 or a management computer that controls one or more aspect of the computing system 10. The computer 30 may communicate with the plurality of servers 22 over a communications network 40, such as a local area network. Furthermore, the communications network 40 allows the computer 30 and the servers 22 to access various types and numbers of data storage devices, such as hard disk drives 50, a redundant array of independent disks (RAID) 52, a removable tape drive 54, and remote/offsite backup drives 56. Other types and configurations of data storage devices may be further included in the computing system 10, including data storage device directly attached to the computer 30 and servers 22.

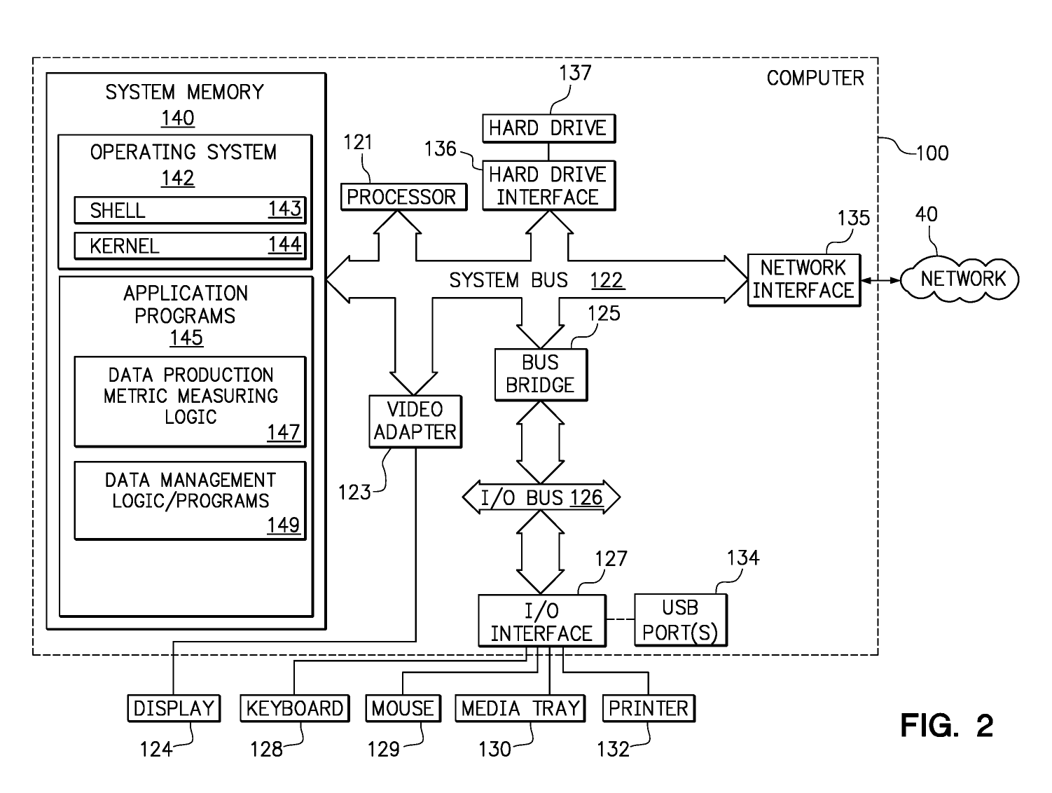

FIG. 2 is a diagram of a computer 100 capable of implementing embodiments of the present invention. The computer 100 that may be included in the computing system 10 of FIG. 1, such as the standalone or management computer 30 or one of the servers 22. In this non-limiting example, the computer 100 includes a processor unit 121 that is coupled to a system bus 122. The processor unit 121 may utilize one or more processors, each of which has one or more processor cores. A video adapter 123, which drives/supports a display 124, may also be coupled to the system bus 122. The system bus 122 may also be coupled via a bus bridge 125 to an input/output (I/O) bus 126. Furthermore, an I/O interface 127 may be coupled to the I/O bus 126 to provide communication with various I/O devices, optionally including a keyboard 128, a mouse 129, a media tray 130 (which may include storage devices such as CD-ROM drives, multi-media interfaces, etc.), a printer 132, and/or USB port(s) 134. As shown, the compute node 100 is able to communicate with other network devices, such as the server 22 or data storage devices 50, 52, 54, 56 (see FIG. 1), via the network 40 using a network adapter or network interface controller 135.

A hard drive interface 136 is also coupled to the system bus 122. The hard drive interface 136 interfaces with a hard drive 137. In a preferred embodiment, the hard drive 137 communicates with system memory 140, which is also coupled to the system bus 122. System memory includes the lowest level of volatile memory in the compute node 120. This volatile memory may include additional higher levels of volatile memory (not shown), including, but not limited to, cache memory, registers and buffers. Data that populates the system memory 140 includes the operating system (OS) 142 and application programs 145.

The operating system 142 includes a shell 143 for providing transparent user access to resources such as application programs 145. Generally, the shell 143 is a program that provides an interpreter and an interface between the user and the operating system. More specifically, the shell 143 executes commands that are entered into a command line user interface or from a file. Thus, the shell 143, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 144) for processing. Note that while the shell 143 may include a text-based, line-oriented user interface, the present invention will equally well support other user interface modes, such as graphical, voice, gestural, etc. As depicted, the operating system 142 also includes the kernel 144, which includes lower levels of functionality for the operating system 142, including providing essential services required by other parts of the operating system 142 and application programs 145, including memory management, process and task management, disk management, and mouse and keyboard management.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the present invention.

The application programs 145 in the system memory of the computer 100 may include, without limitation, data production resource metric measuring logic 147 and data management logic/programs 149 in accordance with various embodiments of the present invention.

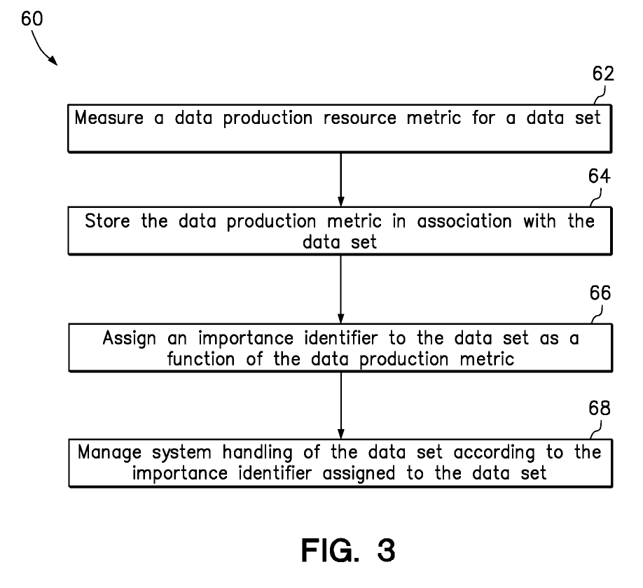

FIG. 3 is a flowchart of a method 60 according to one embodiment of the present invention. In step 62, the method measures a data production resource metric for a data set. In step 64, the method stores the data production resource metric in association with the data set. For example, the data production resource metric may be stored in metadata that is stored with the data set, or the data production resource metric may be stored in a database record along with an identifier for the data set. In step 66, the method assigns an importance identifier to the data set as a function of the data production resource metric. Then, in step 68, the method manages the system's handling of the data set according to the importance identifier assigned to the data set. For example, the importance identifier may affect how a data set is handled by various applications, such as a de-duplication process, backup process, redundancy routine, and a tiering process.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
measuring a data production resource metric for a data set;
storing the data production resource metric in association with the data set;
assigning an importance identifier to the data set as a function of the data production resource metric; and
managing system handling of the data set according to the importance identifier assigned to the data set.

2. The method of claim 1, wherein measuring a data production resource metric for a data set, includes measuring the amount of time required to produce the data set as the data set is produced.

3. The method of claim 1, wherein the data production resource metric is an amount of time required to produce the data set.

4. The method of claim 3, further comprising:
identifying a computing capacity used to compute the data set over the amount of time; and
calculating a current amount of time to replace the data set, wherein the current amount of time to replace the data set is equal to the amount of time identified in the data production resource metric multiplied by a ratio of the computing capacity used to compute the data set and a currently available computing capacity.

5. The method of claim 1, wherein the data production resource metric is an amount of time required to produce the data set, and wherein the amount of time required to produce the data set identifies an amount of time that one or more person spent interacting with an application to create the data set.

6. The method of claim 5, further comprising:
calculating an energy cost of replacing the data set, wherein the energy cost of replacing the data set is equal to the amount of time that one or more person spent interacting with an application to create the data set multiplied by a current rate of energy cost to execute the application.

7. The method of claim 1, wherein the data production resource metric is an energy cost of producing the data set, wherein the metadata further identifies an amount of time and a computing capacity used to compute the data set over the identified amount of time.

8. The method of claim 7, further comprising:
calculating a current energy cost to replace the data set, wherein the current energy cost to replace the data set is equal to the amount of time used to compute the data set multiplied by the computing capacity used to compute the data set and further multiplied by a current rate of energy cost.

9. The method of claim 7, wherein the computing capacity includes infrastructure needed to support computation of the data set.

10. The method of claim 1, wherein the data production resource metric is stored in association with the data set by storing the data production resource metric in metadata stored with the data set.

11. The method of claim 1, wherein the data production resource metric is stored in association with the data set by storing the data production resource metric in a database record along with an identifier of the data set.

12. The method of claim 1, wherein assigning an importance identifier to the data set as a function of the data production resource metric, includes assigning an importance identifier to the data set as a function of the data production resource metric and one or more data usage metric.

13. The method of claim 1, wherein managing system handling of the data set according to the importance identifier assigned to the data set, includes one or more of the following:
making a tiering decision for the data set based on the importance identifier;
establishing a frequency of making a backup of the data set based on the importance identifier;
determining a number of locations to store or backup the data set based on the importance identifier; and
identifying a type of data storage device on which to store the data set based on the importance identifier.

14. The method of claim 1, wherein managing system handling of the data set according to the importance identifier assigned to the data set, include processing the data set with an application selected from de-duplication, backup, redundancy routines, and tiering.

15. The method of claim 1, further comprising:
ranking the data set among a plurality of data sets in order of the importance identifier assigned to each data set.

16. The method of claim 15, wherein managing system handling of the data set according to the importance identifier assigned to the data set, includes managing system handling of the data set as a function of the data set ranking.

17. A computer program product comprising a non-transitory computer readable storage medium having program instructions embodied therewith, wherein the program instructions are executable by a processor to cause the processor to perform a method comprising:
measuring a data production resource metric for a data set;
storing the data production resource metric in association with the data set;
assigning an importance identifier to the data set as a function of the data production resource metric; and
managing system handling of the data set according to the importance identifier assigned to the data set.

18. The method of claim 17, wherein measuring a data production resource metric for a data set, includes measuring the amount of time required to produce the data set as the data set is produced.

19. The method of claim 17, wherein the data production resource metric is stored in association with the data set by storing the data production resource metric in metadata stored with the data set or in a database record along with an identifier of the data set.

20. The method of claim 17, wherein assigning an importance identifier to the data set as a function of the data production resource metric, includes assigning an importance identifier to the data set as a function of the data production resource metric and one or more data usage metric.
